(19) United States
(12) Patent Application Publication
(10) Pub. No.: US 2013/0193059 A1
(43) Pub. Date: Aug. 1, 2013

(54) Reverse osmosis filter flush device and method

(71) Applicant: Scott Shumway, Hinesburg, VT (US)

(72) Inventor: Scott Shumway, Hinesburg, VT (US)

(21) Appl. No.: 13/385,076

(22) Filed: Jan. 31, 2012

(51) Int. Cl. B01D 65/02; F16K 1/00

(52) U.S. Cl. 210/412; 251/318

(57) ABSTRACT

An apparatus and method for reversing the flow in a reverse osmosis system is described utilizing a single unitary valve. The improved system and method provides a means to reduce operating costs, maintenance and down time associated with a reverse osmosis system by providing a reliable and robust means to reverse the flow of fluid thereby flushing filter membranes.

### BACKGROUND OF THE INVENTION

This invention relates generally to fluid treatment systems, and more particularly to a system and method for the continuous cleansing of reverse osmosis membranes contained within the system.

### SUMMARY OF THE INVENTION

The reverse osmosis membrane is well suited to, and accepted for, purifying a variety of liquids, including sea water, ground water, and the like. However, the input surface of the membrane against which the pressurized input fluid to be purified is forced against and through becomes clogged of solid materials which have been filtered out to produce product liquid. As the deposit on the input surface of the membrane increase, efficiency of the membrane decreases rapidly.

A number of U.S. patents attempt to address the issue of cleansing of the filter or reverse osmosis membrane either during use or in conjunction with the interruption of the purifying process. However, none of these disclose the present system or method, nor do these references approach the relatively high efficiency achieved with the present system, both in terms of being devoid of downtime, as well as the unique and highly efficient means to accomplish cleansing of the membrane.

The successful implementation of reverse osmosis technology requires long term reliable operation. With clean inlet water, the systems will function without disruption. However, inlet water is rarely clean, and requires pretreatment steps to remove silt, turbidity and fouling species. Because pretreatment systems are also rarely 100% efficient in the removal of foulants, over time reverse osmosis membrane arrays can lose efficiency due to plugging of the flow passages.

Foulants can include scale, inorganic and/or biological slimes which either originate in the raw inlet water, or can grow in the intake structures of the desalination plant. The problem is well known and has been the target of much research and innovation.

It is therefore an object of this invention to provide a fully automatic self-cleaning reverse osmosis liquid purification system which continually functions to both produce product liquid and to cleanse the membranes simultaneously.

It is another object of this invention to provide a method of cleansing clogged reverse osmosis membranes utilizing a solenoid operated or hydraulically operated valve to reverse the flow of product liquid.

In accordance with these and other objects which will become apparent hereinafter, the instant invention will now be described with reference to the accompanying drawings

### BRIEF DESCRIPTION OF THE DRAWINGS

FIG. 1 is a simplified schematic view of a prior art reverse osmosis system.

FIG. 2 is a simplified schematic view of a prior art reverse osmosis system having discrete valves for flow reversal.

FIG. 3 is a simplified schematic view of an embodiment of the invention.

FIG. 4 is a simplified schematic view of a spool valve in Position A in accordance with an embodiment of the invention.

FIG. 5 is a simplified schematic view of a spool valve in Position B in accordance with an embodiment of the invention.

FIG. 6 is a simplified schematic view of a spool valve in Transition Position in accordance with an embodiment of the invention.

### DETAILED DESCRIPTION

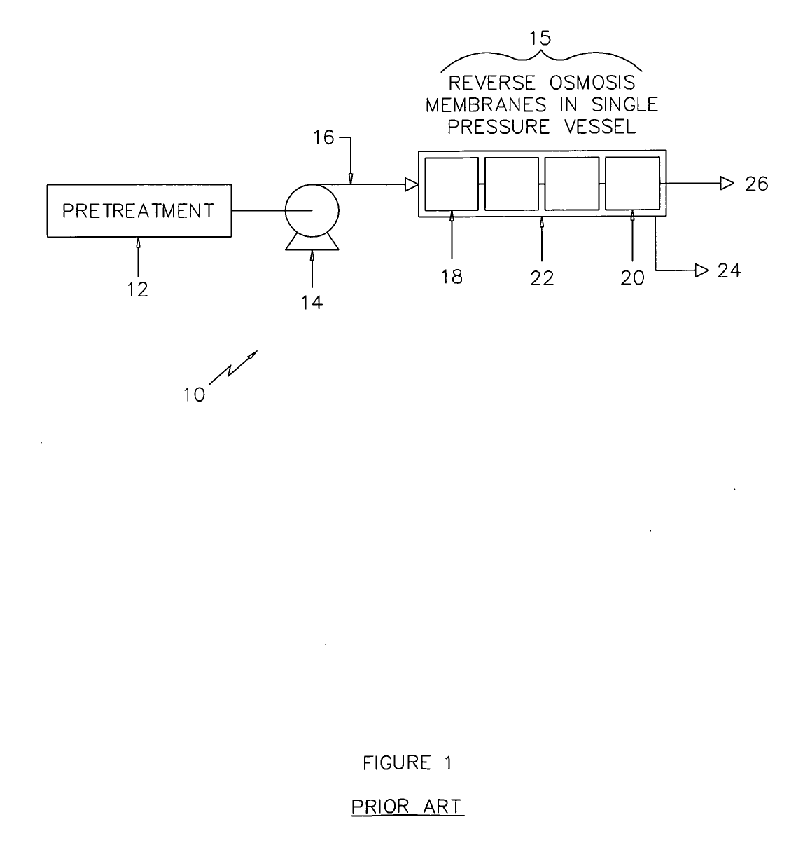

Referring first to FIG. 1, which depicts a reverse osmosis system 10 for filtering water in accordance with the prior art. Pretreated water 12 is supplied to a traditional liquid pump 14 where the pressure of the flow is increased accordingly. In the traditional reverse osmosis membrane array 15, the flow is uni-directional whereby high pressure saline liquid 16 enters the membrane array 15 disposed in a pressure vessel 22, and the first membrane element 18 of each pressure vessel 22 and then the next filter element such that at the point where the flow exits the array 15 from the last membrane element 20 the discharge flow has been converted from saline water 16 to very saline water 24, and a fresh water flow 26 has also been established. Because the flow passages of membrane elements are small, the first element 18 in the pressure vessel 22 is typically subject to more foulants that have survived the pretreatment process 12 than the last membrane element 20. Over time, the membrane array 15 will suffer from reduced flow and will require higher pressures to operate, both of which can damage the membrane array 15.

The current mechanism for addressing this is to use chemical cleaning techniques. This requires that the membrane array 15 be shutdown, and various chemicals are recirculated through the membrane array 15 to restore flow and pressure characteristics to an acceptable level. This process requires additional cost, additional equipment, process downtime and additional cost for the operator. Where inlet water has difficult characteristics or where problems exist with the pretreatment system, membrane fouling can render plants unusable, so there is great interest in design improvements that reduce the requirement for membrane cleaning.

As one skilled in the art can quickly see, one of the primary problems with the membrane arrays 15 is the uni-directional flow. If the flow could be reversed, then foulants that impinge in the leading membrane elements could be removed because the flow would be away from the element instead of into the element. By altering the flow into the membrane array 15 from the front to the rear, and then back again, the tendency of foulants to remain in the membrane array 15 is reduced because the flow will carry debris out of the element from time to time instead of always into the array in the same direction.

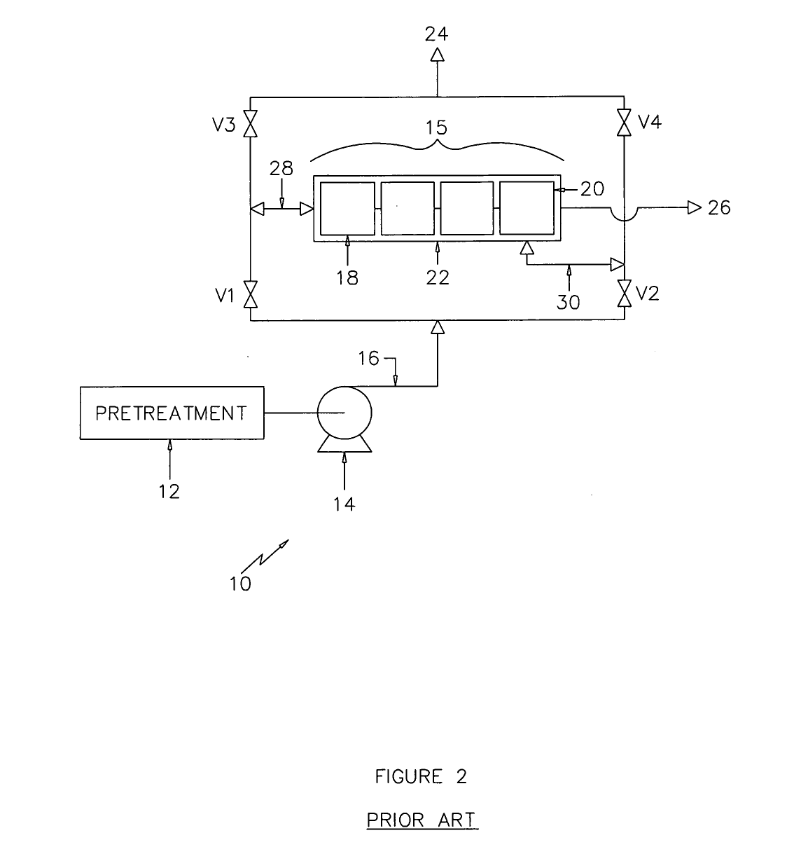

Referring now to FIG. 2, which depicts another reverse osmosis filtering system 10 which employs the use of discrete valves, denoted as V1, V2, V3 and V4 in order to reverse the flow of fluid to flush and clean the filter array 15. This technique is already known, as noted by Japanese Patent JP6079142 to HIDEO, which is incorporated herein by reference. However, from a practical perspective the reversal of flow requires a number of discreet two way valves to achieve the flow reversal, and this added complexity detracts from the implementation of the technique.

The prior art for achieving flow reversal in a membrane array 15 consists of a number of discreet valves (V1, V2, V3, V4) that interrupt and redirect flow such that the inlet and outlet to the membrane array 15 alternate. It is desirable to keep the system online during this process, and therefore the valve timing must be very precise in order to avoid water hammer or pump dead heading. Because of these issues and the cost implications, the implementation of HIDEO is not found in the reverse osmosis industry.

As shown in FIG. 2, saline inlet water is directed from the pretreatment system 12 to the high pressure pump 14. The pump raises the pressure such that the membrane array 15 will separate the saline inlet water into a highly saline flow stream 24 and a fresh water stream 26. The high pressure saline water 16 can be directed to membrane pressure vessel 22 if either V1 or V2 is open or closed. For the purposes of this description we will assume that V1 is open and V2 is closed. In this way, high pressure inlet water 16 is directed to the membrane pressure vessel 22 and membrane element 18 is the leading element and membrane element 20 is the last element in the pressure vessel 22. Note that the pressure vessel may consist of may consist of one vessel containing a single element or multiple elements arranged within the vessel in series, and there may be a single vessel, or multiple membrane pressure vessels in parallel.

Still referring to FIG. 2, V3 is closed and V4 is open. In this configuration, flow will pass from inlet 16 through V1 to pressure vessel 22. Membrane element 18 in this case is the first element and membrane element 20 is the last. Highly saline water exits the vessel 22 at conduit 30 and is directed to outlet 24 through open valve V4. Fresh water is provided from vessel 22 through outlet 26. Outlet 24 may be connected to an additional process for further treatment, a waste stream or energy recovery system, as well known in the art.

To reverse flow through the membrane vessel 22 or array 15 using this prior art design, it is necessary to actuate the various valves. Similar to our example case previously described, inlet water is directed from the pretreatment system 12 to the high pressure pump 14 which creates pressure and flow for the process at 16. While previously the flow was directed through open valve V1 to the membrane pressure vessel 22, in order to reverse flow, V1 is now closed and V2 is open. Flow and pressure are therefore directed through V2 and through conduit 30 to pressure vessel 22. Membrane element 20 is now the first element and membrane element 18 is the last element. With valve V4 closed and valve V3 open, saline water is directed through conduit 30 and the membrane elements 20 through 18 separate the water into highly saline water which exists through conduit 28 and through valve V3 which is open to outlet 24.

Note that in one configuration conduits 30 and 28 have flow in one direction and in the other configuration conduits 30 and 28 have flow in the other direction. The result of this design is that the membrane vessel 22 is subject to reversing inlet and outlet flow whereby membrane elements 18 and 20 alternately are the first and last filter element as defined by the inlet and outlet conditions of the process. While this system is functional, practically, the implementation of this arrangement requires precise valve timing and costly valves. If for instance valves V1 and V2 are closed at the same time during the transition, even briefly, between each aforementioned state, then pump 14 will be deadheaded resulting in water hammer, and similarly if valves V1 and V2 are closed at the same time during the transition, even briefly, the membrane array 15 will lose pressure. In addition, if valves V2 and V3 are open at the same time, the system will not function properly. All of these traits can be damaging and highly undesirable.

The current invention addresses this complexity, and provides for a single simple device and method for flow reversal in a reverse osmosis membrane array. The invention provides for an improved method of reversing flow in a membrane array. The invention replaces a quantity of valves as required to achieve reversing flow as described previously in the prior art with a single unitary device.

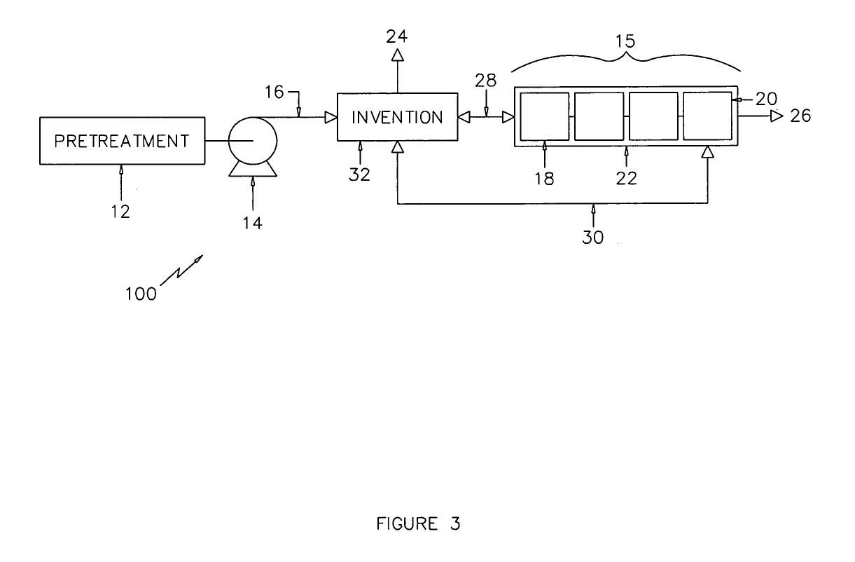

Referring now to FIG. 3, which depicts a simplified schematic diagram in accordance with an embodiment of the invention 100, where like numerals have similar function and purpose, a pretreated fluid 12 is in fluid communication with a high pressure pump 14 as previously discussed. An embodiment of the valve device 32 would have four process connections, the inlet 16 from the high pressure pump 14, a first bi-directional hydraulic conduit process connection 30 to the membrane array 15, a second bi-directional hydraulic conduit process connection 28 to the membrane array 15, and an exhaust outlet 24. During operation, all process connections are at high pressure relative to atmospheric conditions. Note that conduits 28 and 30 would be subject to reversing flow direction conditions whereby conduit 16 would be an inlet only and outlet 24 would be an outlet only. The flow into the valve device 32 would equal the flow out of the valve device 32 at outlet 24 plus the flow out of the membrane array at 26. It is preferable that the membrane array 15 be able to withstand reversing flow.

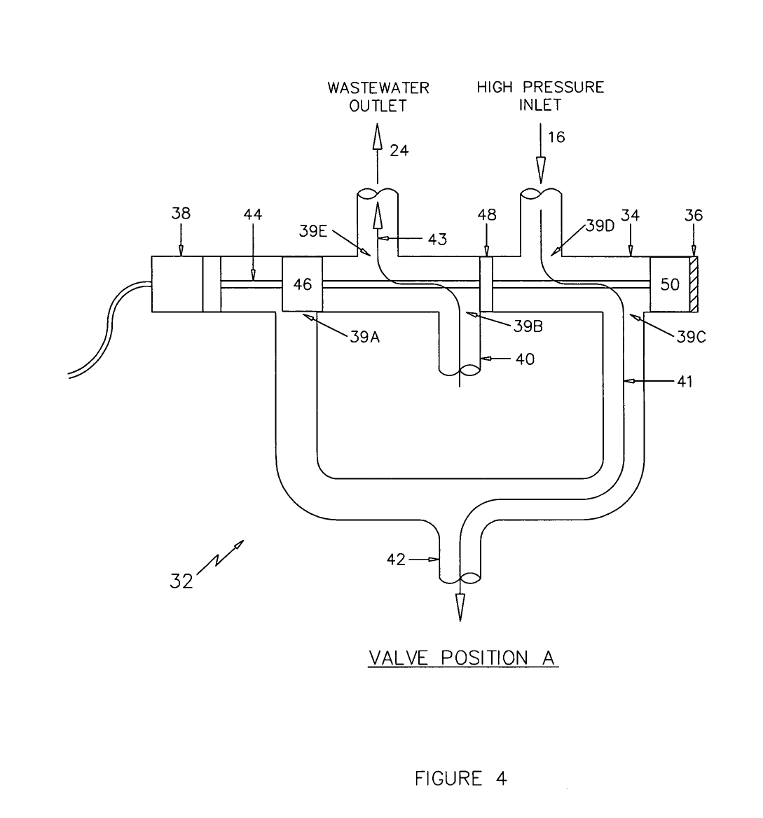

Referring now to FIG. 4, which depicts a simplified layout of the valve 32 in accordance with an embodiment of the invention, whereby the valve 32 is in a position denoted as Position A. A conduit 34 suitably sized for the capacity and pressure of the system is provided whereby one distal end 36 of the conduit 34 is blocked and located at the other distal end of conduit 34 is mounted with a reciprocating actuating device 38 which may be for example an electrically operated solenoid or reciprocating hydraulic actuator. The actuating device 38 may be a reciprocating valve that is actuated by an electronic solenoid, a linear electronic actuator, a cam, an air piston, or a hydraulic actuator. The actuating device 38 could also be a rotary actuating device. The conduit 34 is arranged such that there are six apertures 39a-39e which are suitably sized for the filtration process. These apertures 39a-39e are hydraulically connected via conduits to the desalination process system and consist of inlet 39b from high pressure pump 16, outlet 39e, membrane array connection 39c and 39a which are hydraulically connected together at connection 42.

The actuating device 38 is connected via a shaft 44 to a plurality of separation devices or lands 46, 48 and 50 which are spaced in a predetermined fashion to direct the flow of fluid through the valve 32. The lands 46, 48 and 50 are configured to sealingly and slidingly separate the conduit 34 and apertures 39a-39e into chambers. Preferably, the lands 46, 48 and 50 are configured to minimize or eliminate leakage between the chambers. Preferably, conduit 34 is substantially at the same pressure in all chambers, excepting flow losses. This reduces the driving force required by actuating device 38 which saves cost, weight and complexity.

With this configuration, flow enters the device at inlet 16 and is directed to various apertures depending on the position of the actuating device 38. Similarly, flow enters and exits the device 32 at connection 40 and connection 42 depending on the position of the actuating device 38.

Referring still to FIG. 4, with the valve 32 in Position A, whereby flow is directed from the high pressure pump through aperture 39d into conduit 34. In this configuration, flow is blocked by lands 48 and 50 and fluid flow is directed to aperture 39c through connection 42 to the membrane array as shown by arrow 41. Returning flow is directed to the device through connection 40 through aperture 39b and exhausts through aperture 39e and outlet 24 as shown by arrow 43.

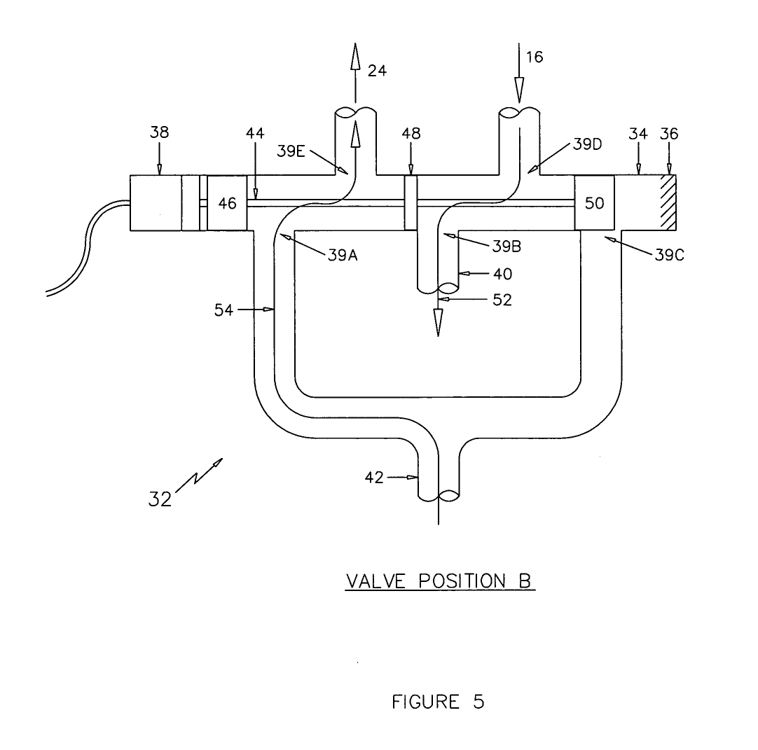

Referring now to FIG. 5, (where like numerals have like meaning) which shows valve 32 in Position B, whereby flow is directed from the high pressure pump through aperture 39d into conduit 34. Flow is blocked by lands 48 and 50 and is directed to aperture 39b through connection 40 to the membrane array as shown by arrow 52. Returning flow is directed to the valve 32 through connection 42 through aperture 39a, disposed between lands 46 and 48 to exhaust through aperture 39e as shown by arrow 54.

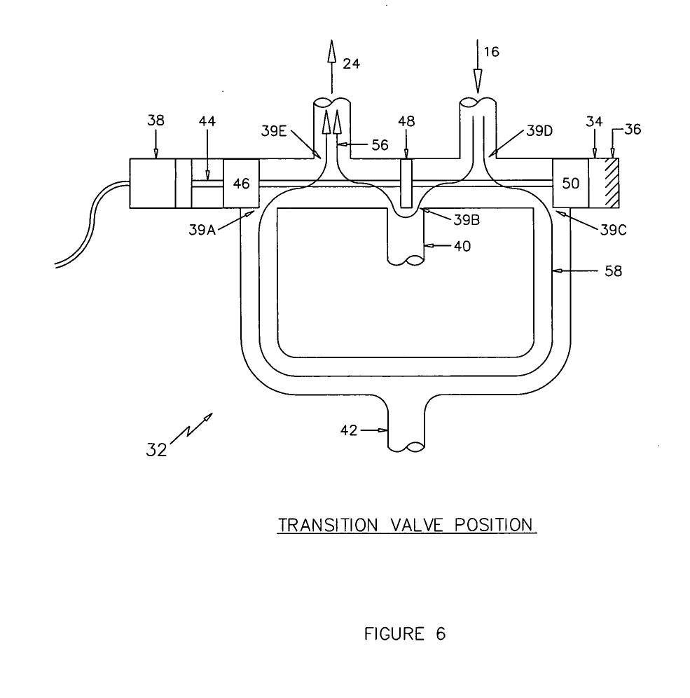

Referring now to FIG. 6, (where like numerals have like meaning) which shows valve 32 in a Transition State in which the actuating device 38 is transitioning between Position A and Position B, and vice versa. Flow is directed from the high pressure pump through aperture 39d into conduit 34. Flow is blocked by lands 48 and 50 and is directed to both apertures 39c and 39b through outlet 42 and outlet 40 to the membrane array. In this transition state, whereby the separation devices 46, 48 and 50 are slidingly and sealingly transferring via the actuation device 38 through shaft 44 from Position A to Position B or vice versa, there is no position where inlet flow from the high pressure pump at aperture 39d is blocked.

The invention is constructed such that lands 46, 48 and 50 are fixed to the shaft 44 and the dimensional relationship between 46, 48 and 50 and apertures 39a-39e are such that in Positions A and B and during transition between those two positions, the apertures are correctly closed or open as required to reverse the flow and improve the filtering process with no down time or damage to the equipment. This configuration also ensures the flow paths from 16 to 40 or 42, and 40 or 42 to 24 are never interrupted even during transition from Position A to B and B to A. It should be noted that the frequency of the transition can be easily tailored to meet the needs of the particular application.

Optionally, during this transition, to reduce any process impacts, the high pressure pump 14 can be turned down to below membrane osmotic pressure prior to transition, and then turned up again after transition.

As can be clearly seen, the invention is relatively low cost to manufacture due to the balanced design and provides for the reduction of foulants in the membrane array due to flow reversal. Another benefit of the invention is the reduction of bio-fouling due to the salinity change whereby the first element is initially subject to saline water inlet, but on reversal is subject to highly saline water, and vice-versa for the last elements in the membrane array. The changing and variable salinity eliminates steady state conditions that biological activity prefers which may restrict or eliminate biomass growth within the system.

In addition to these benefits, the invention may also reduce the requirement for the pretreatment process to provide very clean water to the membrane array which will reduce the pretreatment costs associated with a particular application.

Although an exemplary embodiment of the invention has been shown and described, many changes, modifications, and substitutions may be made by one having ordinary skill in the art without necessarily departing from the spirit and scope of this invention.

What is claimed is:

1. A reverse osmosis filtration system comprising:
a fluid inlet for receiving a flow of contaminated fluid;
a pump configured to raise the pressure of the contaminated fluid;
a filter element configured to capture and retain contaminates present in the contaminated fluid; and,
a single reciprocating valve configured to receive and direct the flow of the contaminated fluid, said valve further configured to reverse the flow of the contaminated fluid through said filter element to substantially remove and flush contaminates disposed in said filter element.

2. The reverse osmosis filtration system of claim 1, wherein said filter element is able to withstand flow in both directions.

3. The reverse osmosis filtration system of claim 1, wherein said reciprocating valve is actuated by one selected from the group consisting of an electronic solenoid, a linear electronic actuator, a cam, an air piston, and a hydraulic actuator.

4. The reverse osmosis filtration system of claim 1, wherein said reciprocating valve further comprises:
an inlet for receipt of the contaminated fluid from said pump;
a first bi-directional hydraulic conduit process connection in fluid communication with said filter element;
a second bi-directional hydraulic conduit process connection in fluid communication with said filter element, and;
an exhaust outlet.

5. The reverse osmosis filtration system of claim 5, wherein said reciprocating valve is configured to selectably direct and reverse the flow of the contaminated fluid through said first and second bi-directional hydraulic conduit process connections to flush contaminates from said filter element.

6. The reverse osmosis filtration system of claim 6, wherein said contaminated fluid is saline water.

7. A reciprocating valve for use in a reverse osmosis filtration system comprising:
an inlet for receipt of a contaminated fluid from a fluid pump;
a first bi-directional hydraulic conduit process connection in fluid communication with a filter element;
a second bi-directional hydraulic conduit process connection in fluid communication with the filter element;
an exhaust outlet, and;
wherein said reciprocating valve is configured to selectably direct and reverse the flow of the contaminated fluid through said first and second bi-directional hydraulic conduit process connections to flush contaminates from the filter element.

8. The reciprocating valve of claim 8, wherein said valve further comprises:
a shaft disposed in a conduit, said shaft having three spaced apart protruding lands disposed along said shaft's longitudinal axis, said lands sealing engaged within said conduit;
an actuating device configured to selectably move said shaft from a first position to a second position, and;
wherein said lands are configured to prevent the blockage of flow of the contaminated fluid through said valve while the shaft is moved between the first position and the second position.

9. The reciprocating valve of claim 8, wherein said contaminated fluid is saline water.

10. The reciprocating valve of claim 8, further comprising an electronically controlled solenoid configured to control the operation of the valve.

11. The reciprocating valve of claim 8, further comprising a hydraulically controlled actuator configured to control the operation of the valve.

12. The reciprocating valve of claim 8, further comprising a rotary actuator configured to control the operation of the valve.
